(19) United States
(12) Patent Application Publication
(10) Pub. No.: US 2022/0378246 A1
(43) Pub. Date: Dec. 1, 2022

(54) APPARATUS FOR MAKING SUGAR CONE SPHERES

(71) Applicants: John Joseph Zarro, Nutley, NJ (US); Michael John Adams, Terrell, NC (US)

(72) Inventors: John Joseph Zarro, Nutley, NJ (US); Michael John Adams, Terrell, NC (US)

(21) Appl. No.: 17/882,734

(22) Filed: Aug. 8, 2022

Related U.S. Application Data
(63) Continuation-in-part of application No. 16/666,072, filed on Oct. 28, 2019, now Pat. No. 11,432,563.

(51) Int. Cl. A47J 37/06

(52) U.S. Cl. CPC A47J 37/0611

(57) ABSTRACT

Apparatus for making treats having wafer shell.

### PRIORITY CLAIM

This application is a United States continuation application having priority to U.S. utility application Ser. No. 16/666,072, filed Monday, Oct. 28, 2019 entitled Methods Of Making Sugar Cone Spheres, which takes priority from U.S. provisional application Ser. No. 62/750,877, filed Oct. 26, 2018 entitled Methods Of Making Sugar Cone Spheres, all of which are hereby incorporated by reference in their entirety as if fully set forth herein.

### FIELD OF THE EMBODIMENTS

This invention relates to apparatus for making treats having wafer shell.

### BACKGROUND OF THE EMBODIMENTS

A favorite food of adults and children alike during the summer months is undoubtedly ice cream in a waffle cone. On hot days, the ice cream or especially frozen yoghurt can melt rapidly spoiling clothes and causing a mess. The size of ice cream cones is also inconvenient to handle.

It is desirable to have ice cream treats that are easier to consume.

Examples of related art are summarized below.

U.S. Pat. No. 4,209,536 describes a substantially spherical filled food product comprising an outer closed shell of pastry enclosing a soft filling. The shell is seamless and consists of an oven-baked yeastless pastry having a humidity content not exceeding 1 wt. %. The shell has a coarse-cellular inner structure, with the cell size decreasing towards the exposed outer surface of the shell, said outer surface being substantially impervious to air and humidity. No yeast is used in the dough for the shell; the cellular structure-building aid in the dough is the white of egg. The outer diameter of the shell is from 10 mm to 20 mm, while the weight ratio of the filling to the shell is at least 2:1. The product is buoyant in comestible aqueous liquids such as fruit juice or milk.

U.S. Pat. No. 7,404,978 describes a wafer half-shell which has a mouth delimited by at least one annular surface and one or more side walls, in which the mouth surface and the surfaces of the side wall have a substantially smooth surface finish. Preferably the outer surface of the side wall has a porous, continuous or discontinuous region which extends peripherally and is receded relative to the mouth surface of the half-shell, resulting from the cutting of a radial wall connected to the side wall of the half-shell in a receded position relative to the annular surface defining the mouth of the half-shell. The annular coupling surfaces of the complementary half-shells have preferably centering means which are complementary each other. The half-shell is useful particularly for the production of a food product comprising a pair of half-shells fitted together mouth to mouth and including a mass of liquid filling.

European Patent No. 614614 describes a method of joining lines of adhesive alimentary material such as chocolate on products such as hemispherical wafer half-shells, the respective opening portions of which are to be joined together. For this purpose, the adhesive material is applied to a transfer surface in the form of a substantially continuous layer or in the form of piping of a shape representing the shape of the joining line to be formed. The opening portions of the products are then dipped in the continuous layer or piping of adhesive alimentary material.

U.S. Pat. No. 4,430,351 pertains to a confectionery product comprising a shell formed by two wafer shell halves jointly enclosing a filling. The filling has a water content not tolerable by the shell of wafer and is contained in a water-impermeable capsule of edible material, lining or bonded to the internal surface of the shell.

None of the art described above addresses all of the issues that the present invention addresses. The apparatus for making a sugar cone sphere disclosed herein is used for molding half spherical wafers, filling them with ice cream or frozen yoghurt, joining two of them at their midline and freezing them together to produce a bite-size sugar cone sphere.

### SUMMARY OF THE EMBODIMENTS

The present disclosure relates to apparatus for making treats, such as bite-size treats with an outer wafer sugar cone treats containing a desert such as ice cream or frozen yoghurt encapsulated by a wafer shell that prevents spillage of the ice cream if it melts.

It is an object of the disclosure to provide apparatus for making sugar cone spheres having an interior of ice cream or frozen yoghurt that is encapsulated by a continuous waffle wafer where the sugar cone spheres are made by joining and freezing together two half waffle spheres filled with ice cream.

Apparatus for producing bite-size treats enclosed within a wafer shell, comprising a wafer iron that includes: an upper piece containing a heating element and an upper cooking plate that has a cooking surface with at least one pair of matching protuberances with dimensions and a periphery shape at the intersection of the protuberances with the upper cooking plate. The wafer iron also has a lower piece containing a heating element and a lower cooking plate that has a cooking surface with a same number of pairs of matching indentations concentric with corresponding matching protuberances, the indentations having the same periphery shape at the intersection of the indentations with the bottom cooking plate as the corresponding protuberances' periphery shape. The indentations have dimensions greater than the dimensions of the corresponding protuberances by an amount in the range of 0.1-0.3 inch. A hinge couples together the upper piece and the lower piece, so that the upper piece can swing down over the lower piece. A power source is coupled to the heating elements in the upper and lower pieces.

### BRIEF DESCRIPTION OF THE DRAWINGS

FIG. 1 depicts a top perspective detailed view of an exemplary waffle baking machine with temperature/color control and indicator lights showing when the wafer dough mix is baking and when baking is complete.

FIG. 2 is a perspective view of an exemplary waffle iron having a hinge connected to both upper and lower heated cooking plates.

FIG. 3 shows a perspective detailed view of an exemplary waffle iron with the upper cooking plate placed on top of the lower cooking plate.

FIG. 4 shows a top view of exemplary convex and concave hemispherical molds.

FIGS. 5A and 5B show side and top views respectively of an example shape cutter outer cylinder.

FIGS. 5C and 5D show top and side views respectively of an example shape cutter inner cylinder.

FIG. 5E depicts a piece of a waffle with a portion molded into a hemispherical shape.

FIG. 5F depicts a waffle hemispherical shell after being cut from a waffle by the shape cutter shown in FIGS. 5A-D.

FIG. 6 shows a an example waffle portion with a circular cut out, upper and lower hemispherical molds, and a hemispherical waffle shell.

FIG. 7 shows a top view of exemplary brushes used to coat the hemispherical waffle shell with molten chocolate.

FIG. 8 shows a perspective view of an exemplary bite-size sugar cone sphere.

FIG. 9 shows a top view of the exemplary bite-size sugar cone sphere of FIG. 8.

FIGS. 10 and 11 are top and perspective views, respectively, of an exemplary concave mold.

FIG. 12 is a front perspective view of the top of the lower heating plate of the wafer iron of FIG. 14.

FIG. 13 is a bottom view of the upper heating plate of the wafer iron of FIG. 14.

FIG. 14 is a front perspective view of an exemplary wafer iron used to make sugar cone spheres, showing upper and lower heating plates coupled together with a hinge.

FIG. 15 is a side view of the exemplary concave mold of FIG. 11 containing just-produced wafer half shells.

FIGS. 16A and 16C are bottom and side schematic views, respectively, of an example upper heating plate of a wafer iron.

FIGS. 16B and 16D are top and side schematic views, respectively, of an example lower heating plate of a wafer iron.

FIG. 16E is a side schematic view of example upper and lower heating plates of an example wafer iron coupled together with a hinge.

FIG. 17 is a perspective view of an example cutter for cutting circles in a wafer. Such circles may be the cut edges of hemispherical shapes cut from a wafer made using a wafer iron.

### DETAILED DESCRIPTION

Example embodiments and aspects will now be described with reference to the drawings in which the same elements in the various figures are identified with the same reference numerals. These embodiments are provided by way of explanation of the present invention, which is not intended to be limited thereto. Rather, the scope of the invention is defined by the claims. Those of ordinary skill in the art may appreciate upon reading the present specification and viewing the present drawings that various modifications and variations can be made to the disclosed and illustrated embodiments and aspects. Such variations are included in the claims if they fall within the scope of the claims or their equivalents.

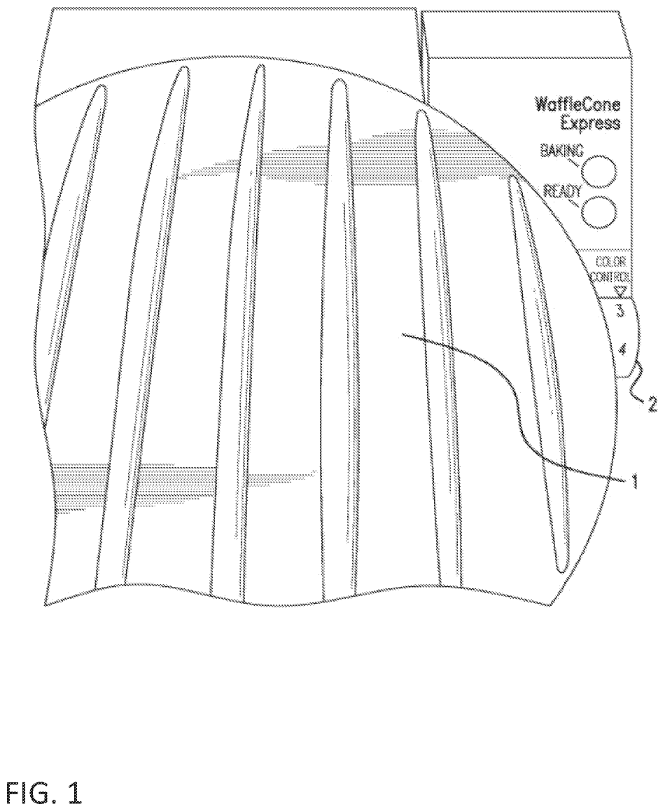

FIGS. 1-3 disclose an exemplary depiction of an electric WaffleCone baking machine.

FIG. 1 shows the top of the upper waffle iron 1 and a color control 2 that regulates the baking temperature. The waffle iron is preheated by setting the desired waffle color and swinging the upper plate 3 into place above the lower plate 4. The LED light “READY” signals when the upper and lower waffle plates have reached the set temperature. The user then opens the waffle iron, applies the waffle dough to the lower plate, and lowers the upper plate again to squeeze the waffle dough evenly between the plates. The LED light “BAKING” indicates when baking of the wafer dough mix is in progress.

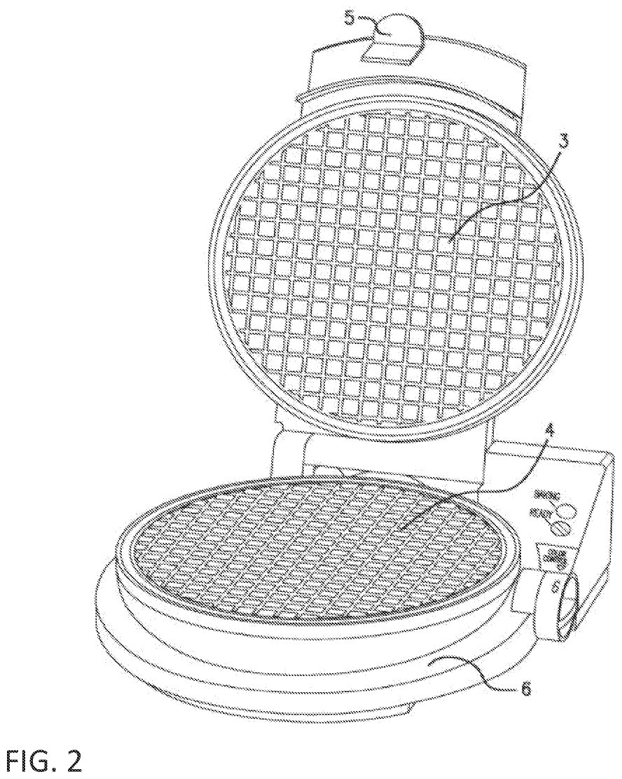

FIG. 2 depicts the WaffleCone baking machine, showing a handle 5, a hinge-connected heated upper waffle iron 3 and lower waffle iron 4, and a base 6.

As shown in FIG. 3, the upper and lower waffle irons (3, 4) are opposite to each other when closed. The waffle iron can have a grid pattern that is rectilinear with the pattern lines running predominantly from the front of the waffle maker to the rear and from left to right. The waffle dough mix is spread evenly across the lower waffle plate 4. Generally the mix is introduced manually onto the center of the lower waffle plate 4, and is then spread out between the upper and lower plates (3, 4) as the upper plate is lowered onto the lower plate. The waffle wafer is baked until the consistency of the wafer is soft and spongy.

In embodiments, the waffle iron can be configured to make the thickness of the cooked wafer in the range of about 0.1-0.5 inch thick.

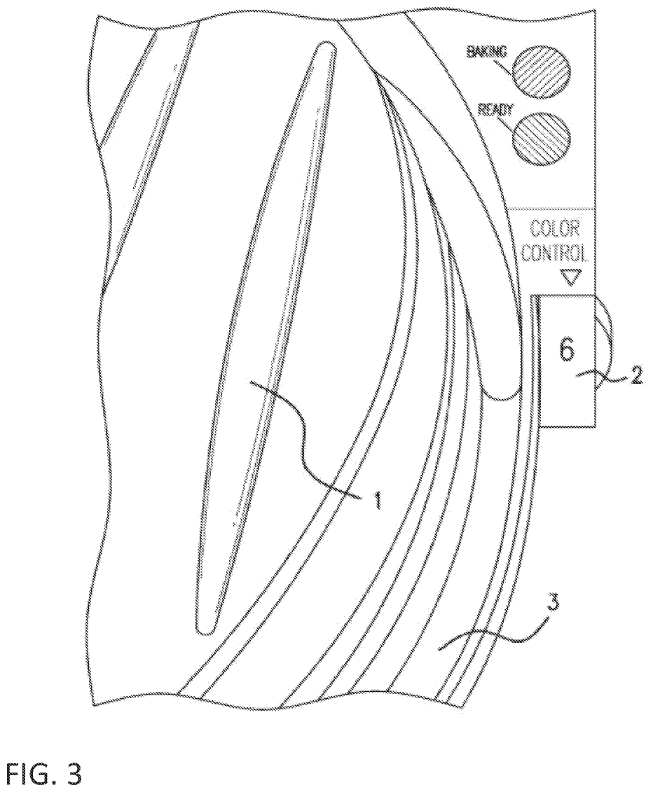

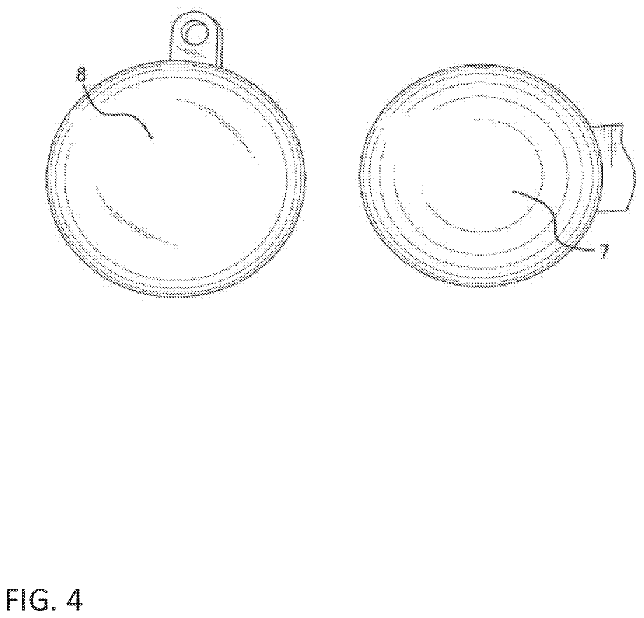

FIG. 4 shows a protuberance 8 and an indentation 7 that would be placed in the upper and lower plates, respectively, such that the protuberance 8 will be inserted into the indentation 7 when the upper plate 3 is swung down into its cooking position above the lower plate 4.

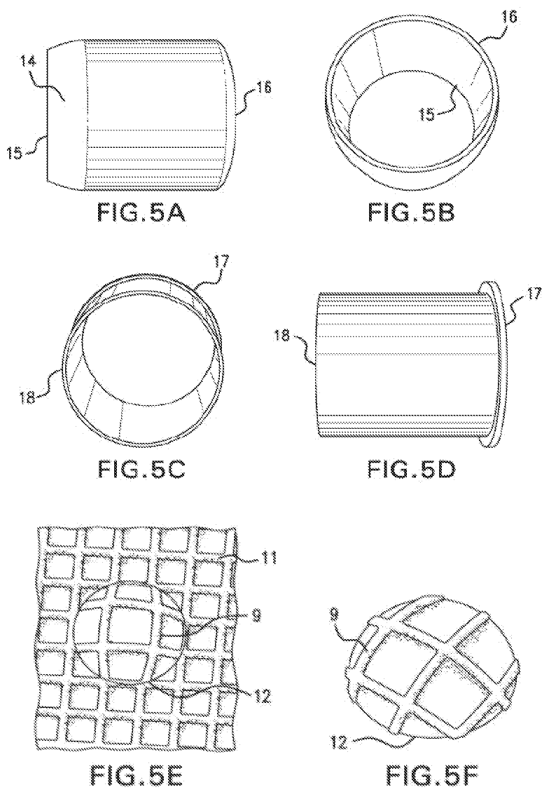

FIGS. 5A to 5D are views of an exemplary cutter for cutting a circular shape out of a cooked wafer. FIG. 5E depicts a portion of a cooked wafer containing a hemispherical shape with a circular base, and FIG. 5F shows the cooked hemispherical shape cut out of the wafer. As shown in FIGS. 5A-5F, a portion of the wafer 11 can be shaped into a hemispherical shape 9 by placing the wafer between the upper and lower molds, and pressing the inner (lower) hemispherical protuberance mold 8 against the outer (lower) hemispherical indentation mold 7 to produce a hemispherical shape 9. The diameter of the outer (lower) hemispherical indentation mold may be in the range of about 0.1-0.3 inches greater than the diameter of the inner (upper) hemispherical protuberance mold to allow for the placement of the inner mold into the outer mold and determine the thickness of the wall of the hemispherical shape 9. In embodiments, the hemispherical shape 9 can have an outer diameter in the range of about a half inch to about about 2 inches. The hemispherical shape 9 is cut from the wafer at the midline 12 using a circular cylindrical cutter that can be placed over the hemispherical shape 9 (see FIGS. 5A-5D).

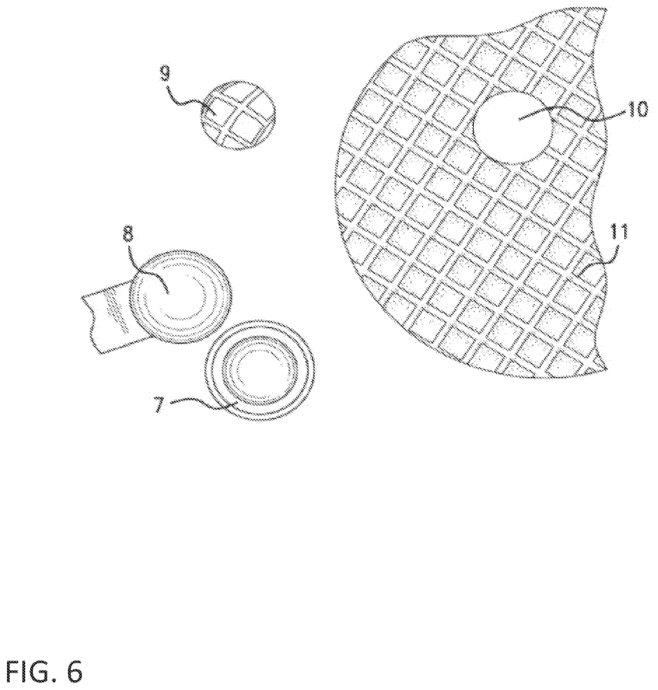

The cylindrical cutter comprises an outer cylinder depicted in side and perspective views respectively in FIGS. 5A-5B. The outer cylinder has a circular bottom 15, an outwardly sloping spacer 14 and a circular top 16. The cutter also comprises an inner cylinder depicted in perspective and side views respectively in FIGS. 5C-5D. The inner cylinder has a circular top 17, and a circular bottom 18 that has a sharp edge. In embodiments, the inner cylinder has an inner diameter that approximates the diameter of the hemispherical shape 9. Further, the inner diameter of the outer cylinder can be in the range of about 0.1-0.3 inch greater than the outer diameter of the inner cylinder to allow for movement of the inner cylinder within the outer cylinder. To cut the hemispherical shape 9 out of the wafer, the circular aperture at the bottom 15 of the outer cylinder is placed over the hemispherical shape 9 portion of the wafer 11 (see FIG. 5E). The circular bottom 18 of the inner cylinder is placed inside the outer cylinder through the aperture at the top of the outer cylinder 16. Pressure is applied to the circular top 17 of the inner cylinder to cut along the periphery of the hemispherical shape 9 at the midline 12 (see FIG. 5F) where two hemispheres will be joined. FIG. 6 depicts the circular cut out 10 of the wafer 11, the hemispherical shape 9, and the inner (upper) mold 8 and outer (lower) mold 7.

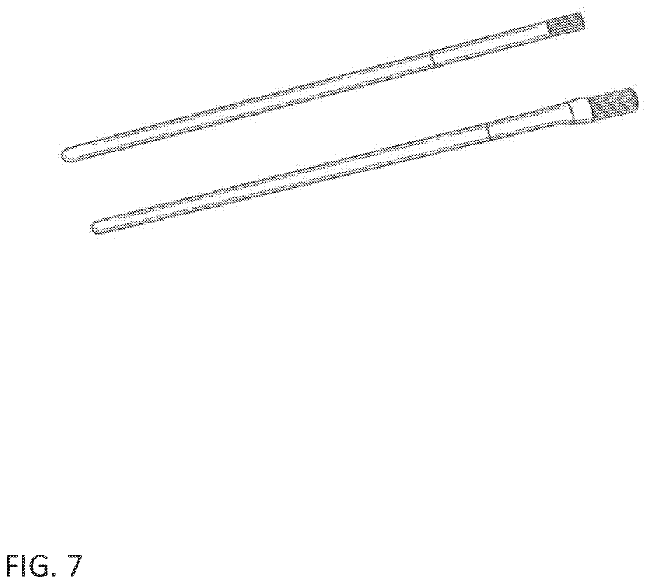

FIG. 7 depicts brushes that may be used to apply molten chocolate and/or icing or other liquid confections in any desired combination, to the interior and/or exterior surface of the hemispherical shape 9. An edible filling may also be added to the interior of the hemispherical shape 9. The edible filling can be, for example, ice cream, frozen yoghurt, a crème filling, chocolate covered cherry, or other dessert. The filling can have one flavor or multiple flavors. Exemplary flavors include, but are not limited to, vanilla, strawberry, chocolate, pineapple and cheesecake. In embodiments the edible filling may include, for example, candy, chocolate chips, M&Ms, fragments of fruit, or any other desired treat that will fit inside the wafer shell, either alone or in any desired combination.

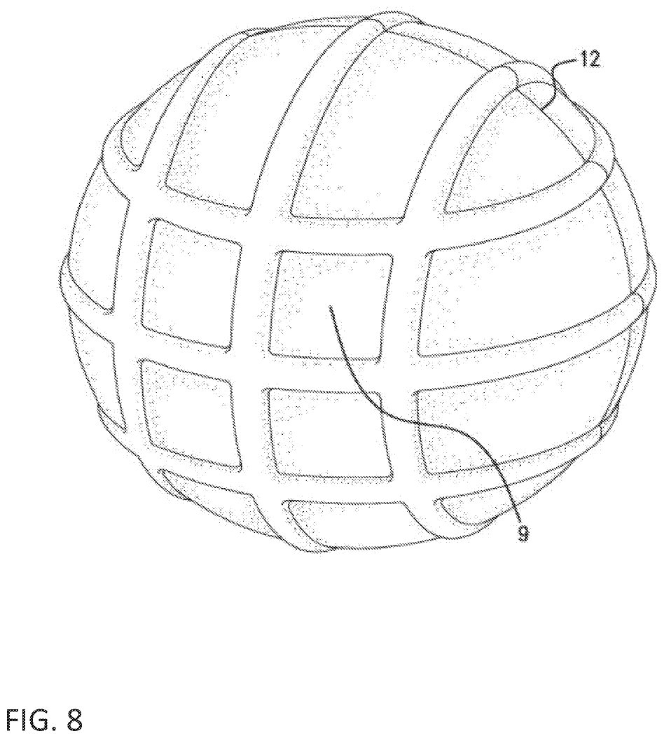

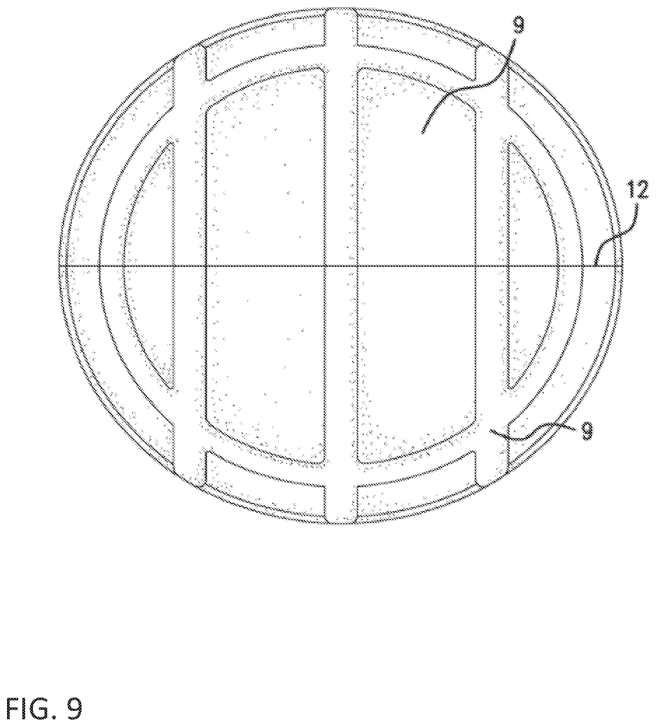

As shown in FIGS. 8-9, two hemispherical shapes 9, one or both filled with the edible filling such as ice cream, are joined together at their midline 12 and frozen to produce a convenient, easy to handle, and easy to eat bite-size sugar cone sphere containing any desired filling.

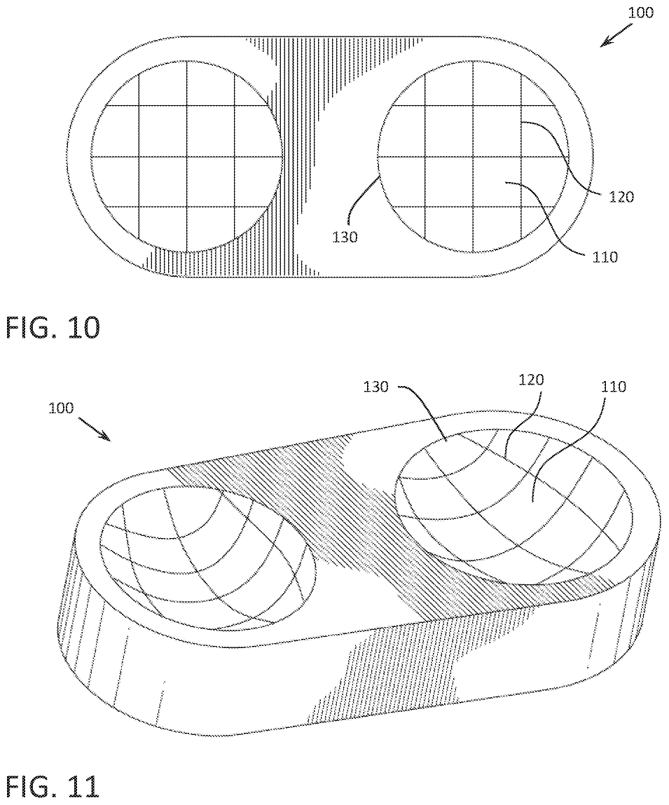

FIG. 10 is a top view, and FIG. 11 is a perspective view, of a mold 100 for making wafer spheres having a surface pattern similar to a waffle. The mold is configured with two concave circular hemispherical indentations 110 for making two cooked hemispheres with matching waffle patterns. The mold's crossing lines 120 represent grooves that fill with batter, such as waffle or pancake batter, which when cooked form ridges in the waffle-like surface. When the cooked halves are cut along their circular periphery 130 and joined together at their peripheries, the resulting sphere is similar to that shown in FIG. 8. Both hemispheres of the mold may be completely filled with batter which may be flavored as desired, cooked, cut out around the circular periphery 130, and joined, for example with a confection with adhesive properties that may also be flavored as desired. For example, the batter may be waffle batter with blueberry flavor added, and assembled into a sphere using a confection with butter and maple flavoring, thereby making a tasty, easy to consume breakfast food.

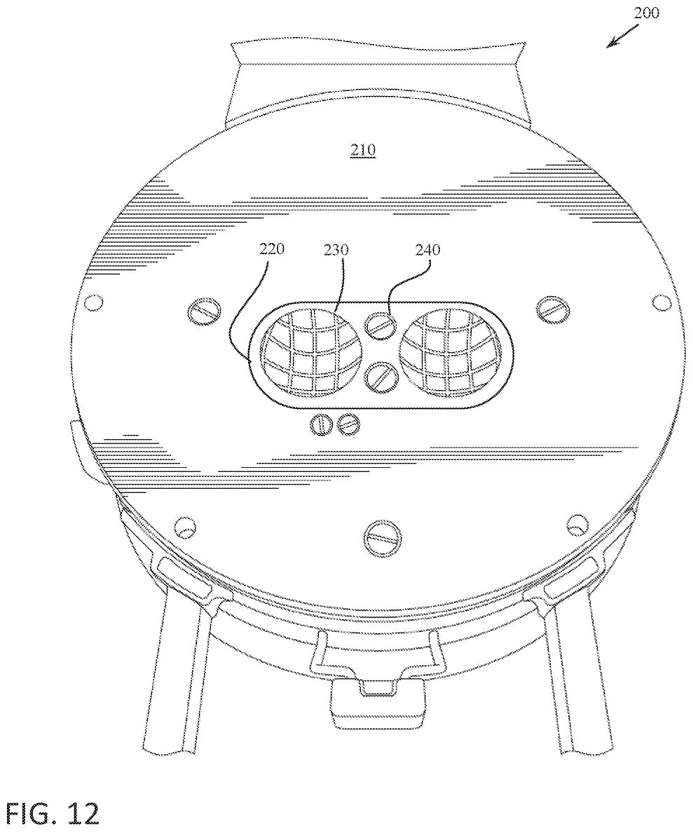

FIG. 12 is a perspective view of the lower piece 200 of a wafer iron 100 with a lower baking plate 210 having a smooth cooking surface. The lower baking plate has an opening in the center of the cooking surface sized and configured to receive a mold 220 similar to the mold 100 of FIGS. 10 and 11, in that it has two concave hemispherical indentations 230 with surfaces having grooves. In addition, the mold 220 is held in place by two screws 240 that screw into threaded holes (not shown) in the lower piece 200.

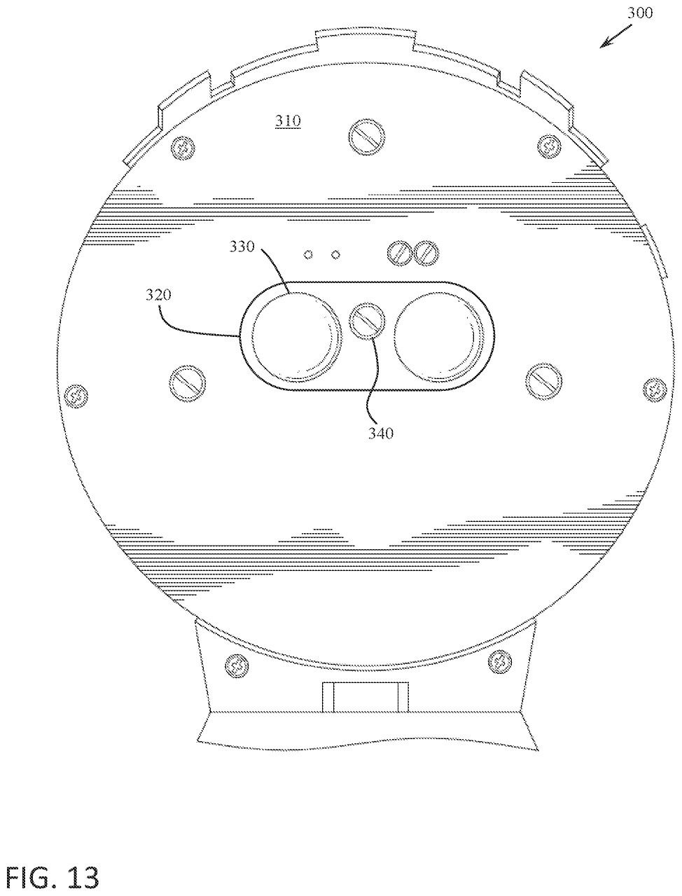

FIG. 13 is a bottom view of the upper piece 300 of the wafer iron 100, with an upper baking plate 310 having a smooth cooking surface. Similar to the lower baking plate 210, the upper baking plate 310 has an opening in the center of the cooking surface sized and configured to receive a mold 320 that has two convex hemispherical protuberances 330 with smooth surfaces. The mold is held in place by a single screw 340 that screws into a threaded hole (not shown) in the upper piece 300.

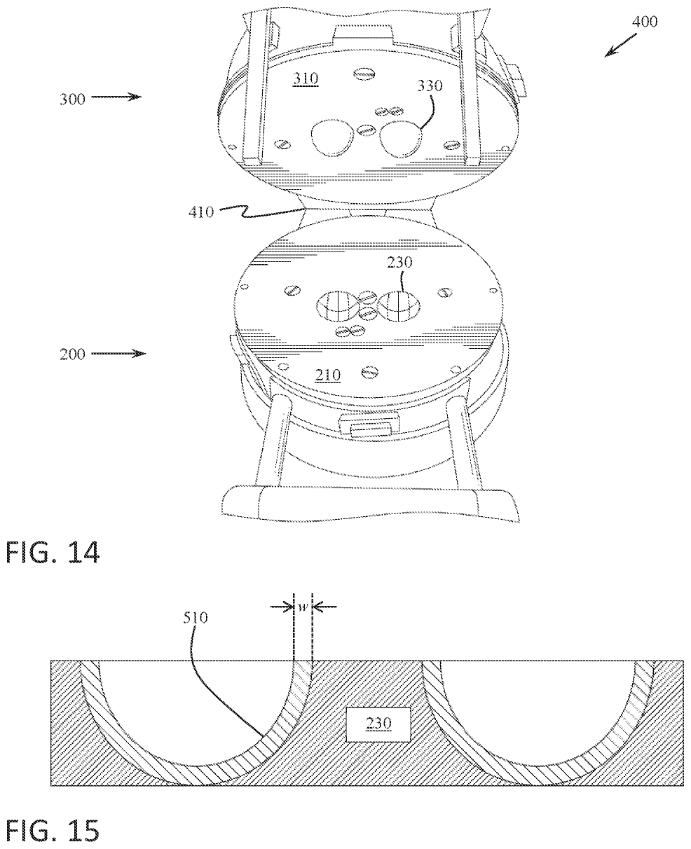

FIG. 14 is a perspective view of a wafer iron 400 having a lower piece 200 and an upper piece 300, coupled together with a hinge 410. When the upper piece 300 is swung down into a cooking position above the lower piece 200, the hemispherical protuberances 330 mounted in the upper baking plate 310 are inserted into the hemispherical indentations 230 mounted in the lower baking plate 210. The protuberances 330 preferably have a radius in the range 0.1 inch to 0.3 inch smaller than the indentations 230, and are arranged to fit into the indentations 230 such that batter placed in the indentations is pushed against the indentations' surfaces to form hemispherical cups. The cups have a wall thickness determined by the difference in the radius of the protuberances 330 and the indentations 230, in this example in the range of 0.1 inch to 0.3 inch.

FIG. 15 is a cross sectional view of the example mold 100 containing hemispherical cups 510 of cooked batter. In this example, the cups 510 have a wall thickness w preferably in the range of 0.1 inch to 0.3 inch, although other thicknesses may be used.

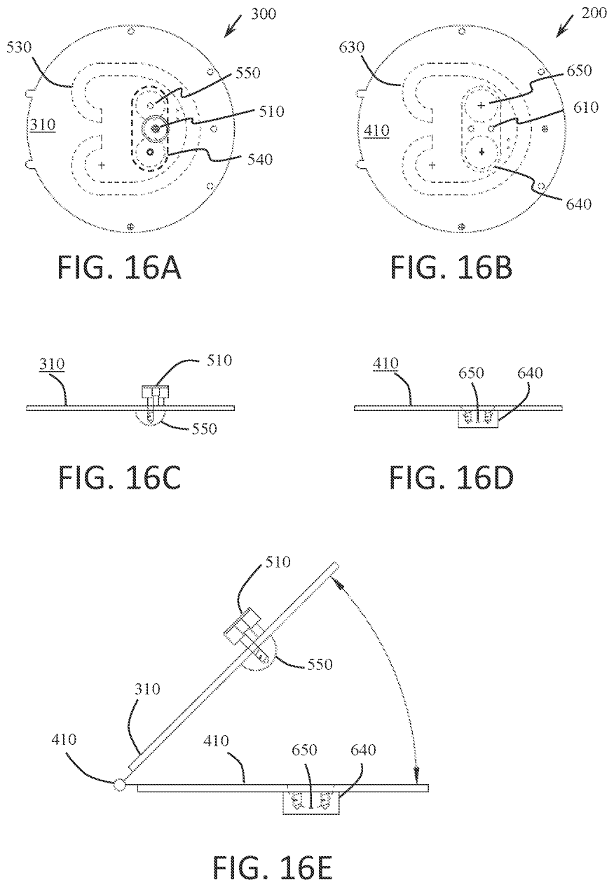

FIG. 16A is a bottom schematic view of an example wafer iron upper piece 300, having an upper cooking plate 310 and a screw 510 securing a mold 540. The mold 540 is inserted into a cutout in the plate 310 and screwed in place, and has two hemispherical protrusions 550. Shown in phantom are a heating coil 530 and the protrusions 550 in mold 540.

FIG. 16B is a top schematic view of an example wafer iron lower piece 200, having a lower cooking plate 410 and two screws 610 securing a mold 640. The mold 640 is inserted into a cutout in the plate 410, and has two hemispherical indentations 650. Shown in phantom are a heating coil 630 and the indentations 650 in mold 640.

FIG. 16C is a side schematic view of a portion of the example wafer iron upper piece of FIG. 16A, showing an upper cooking plate 310 and a screw 510 securing the mold that has hemispherical protrusions 550.

FIG. 16D is a side schematic view of a portion of the example wafer iron lower piece of FIG. 16B, showing a lower cooking plate 410 and the mold 640 having hemispherical indentations 650 (shown in phantom), secured with screws.

FIG. 16E is a side schematic view of an portion of an example wafer iron, showing the upper plate 310 that holds a mold having a pair of protuberances 550 secured with a screw 510. The upper portion is hingedly coupled to the lower portion having a lower plate 410 that holds a mold 640 having a pair of indentations 650. In embodiments, the lower plate 410 may be equipped with a plurality of molds 640 providing pairs of indentations 650, and the upper plate 410 is equipped with molds 640 providing corresponding pairs of indentations 650. In use, each pair of lower and upper molds forms two hemispherical shells which, when joined together at their circular periphery, form a single complete wafer sphere. As previously described, before being assembled one or both hemispheres may be filled with any desired treat such as ice cream, frozen yoghurt, candies, cakes, or any other desired confections either alone or in any desired combination. The filled spheres may further be prepared and served at any desired temperature, for example, frozen or heated to any desired temperature that will be enjoyable to eat.

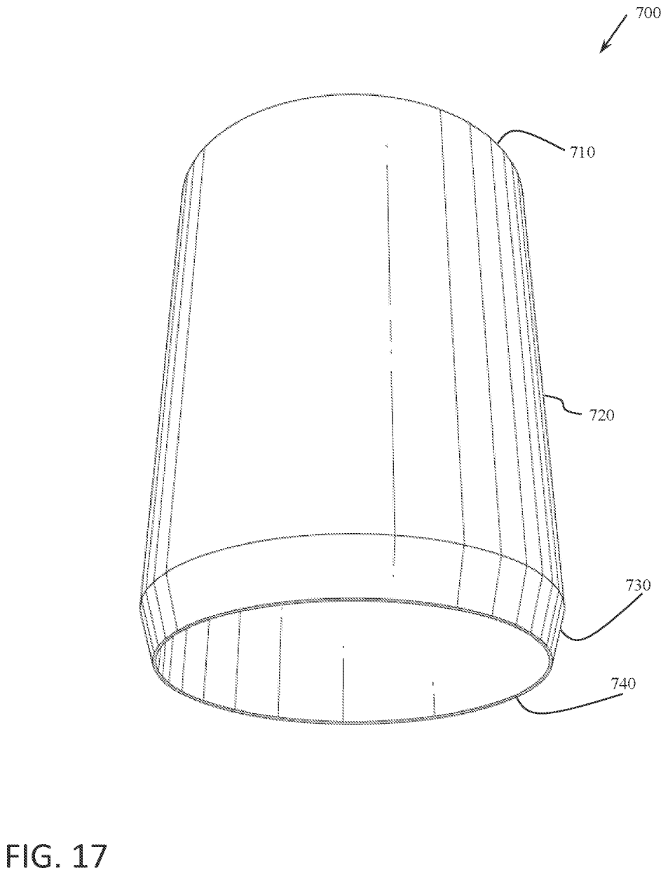

FIG. 17 is a cutter 700 with a top 710, and a side 720 with a portion 730 that narrows at the bottom of the cutter to a circular cutting edge 740. The diameter of the cutting edge is the same as that of the edge 130 of the concave hemispherical indentations 110 in the mold(s) 100 disposed in the lower plate 210.

In use, wafer batter is poured into the concave indentations 110 in the one or more molds 100 disposed in the heated lower plate 410 of the lower piece 200 of wafer iron 400. The upper piece 300 is then lowered over the lower piece 200, so that the heated upper plate 310 is a distance w away from the heated lower plate 410 to cook the batter. When the batter is cooked a desired amount, the upper piece 300 is raised away from the lower piece 200. The cutter 700 may then be used to cut the cooked batter at the periphery of each of the hemispherical indentations 100, and the hemispherical wafer halves are then removed from the mold. The halves may then be filled with a desired filling, and the halves joined together in pairs at the circular edges of the hemispheres to form a filled sphere. The temperature of the filled sphere may then be adjusted by heating, cooling, or freezing, depending on the filling and the desired end product. The end product is then ready to eat.

It is noted that the foregoing description focuses on apparatus for making spherical shells. However, appropriately configured molds may be used to form shells having other shapes, such as a right prism having any desired polygonal cross sectional shape, an egg shape, a pyramid having any desired regular polygonal base, and the like.

Although this invention has been described with a certain degree of particularity, it is to be understood that the present disclosure has been made only by way of illustration and that numerous changes in the details of construction and arrangement of parts may be made without departing from the spirit and scope of the invention.

What is claimed is:

1. Apparatus for producing bite-size treats enclosed within a wafer shell, comprising:
a wafer iron that includes:
an upper piece containing a heating element and an upper cooking plate with a cooking surface having at least one pair of matching protuberances with dimensions and a periphery shape at the intersection of the protuberances with the upper cooking plate;
a lower piece containing a heating element, and a lower cooking plate with a cooking surface having a same number of at least one pair of matching indentations concentric with corresponding matching protuberances, the indentations having the same periphery shape at their intersection with the lower cooking plate as the corresponding protuberances' periphery shape, and having dimensions greater than the dimensions of the corresponding protuberances by an amount in the range of 0.1-0.3 inch;
a hinge that couples together the upper piece and the lower piece; and
a power source coupled to the upper piece heating element and the lower piece heating element.

2. The apparatus of claim 1, further comprising an off/on control to turn the wafer iron on and off.

3. The apparatus of claim 1, further comprising a first selector for selecting a cooking temperature to which the upper and lower cooking plates are heated.

4. The apparatus of claim 1, further comprising a second selector for selecting a cooking duration, and a sound generator that generates a sound indicating the cooking duration has been reached.

5. The apparatus of claim 1, wherein each of the pair(s) of protuberances in the upper piece and the corresponding pair(s) of indentations are included in a removable mold.

6. The apparatus of claim 1, wherein the protuberances and the indentations have convex and concave hemispherical shapes, respectively.

7. The apparatus of claim 6, wherein a radius of the protuberances is less than a radius of the corresponding indentations by an amount in the range of 0.1-0.3 inch.

8. The apparatus of claim 7, wherein the upper plate is lowered over the lower plate containing wafer batter poured into the indentations, thereby inserting the protuberances into corresponding concentric indentations and pressing and spreading the wafer batter between a surface of the indentations and a surface of the protuberances.

9. The apparatus of claim 1, wherein an outer dimension of the indentations shape is in a range of 0.5 inch to 2 inches.

10. The apparatus of claim 1, wherein surfaces of the indentations have at least one of grooves and ridges.

11. The apparatus of claim 1, wherein surfaces of the indentations are inscribed or embossed with at least one graphic.

12. A system for producing bite-size treats enclosed within a wafer shell, comprising:
a wafer iron that includes:
an upper piece containing a heating element and an upper cooking plate with a cooking surface having at least one pair of matching protuberances with dimensions and a periphery shape at the intersection of the protuberances with the upper cooking plate;
a lower piece containing a heating element, and a lower cooking plate with a cooking surface having a same number of at least one pair of matching indentations concentric with corresponding matching protuberances, the indentations having the same periphery shape at the intersection of the indentations as the corresponding protuberances' periphery shape, and having dimensions greater than the dimensions of the corresponding protuberances by an amount in the range of 0.1-0.3 inch;
a hinge that couples together the upper piece and the lower piece; and
a power source coupled to the upper piece heating element and the lower piece heating element; and
a cutter with a cutting edge having the same shape and dimensions as the periphery of the lower piece indentations.
